(19) United States
(12) Patent Application Publication
(10) Pub. No.: US 2005/0204768 A1
(43) Pub. Date: Sep. 22, 2005

(54) Air conditioner

(75) Inventors: Thomas Di Vito, Bad Homburg (DE); Georg Weber, Egelsbach (DE); Tilo Schaefer, Daubach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Fahrzeug-Hydraulik GmbH & Co.KG, Bad Homburg v.d.H. (DE)

(21) Appl. No.: 10/506,599

(22) PCT Filed: Feb. 20, 2003
(86) PCT No.: PCT/DE03/00530

§ 371 Date: Apr. 15, 2005

(30) Foreign Application Priority Data
Mar. 4, 2002 (DE) 102 09 412.8

(51) Int. Cl. B60H 1/32; F25B 13/00; F25B 1/00

(52) U.S. Cl. 62/324.1; 62/244; 62/498

(57) ABSTRACT

An air conditioning system is provided for heating and/or cooling a passenger compartment of a motor vehicle, the system including a compressor, wherein the one compressor powers at least two air conditioning circuits in at the same time (i.e., in parallel).

The present invention relates to an air conditioning system, in particular for motor vehicles, including a compressor; such air conditioning systems being used mainly for cooling a passenger compartment.

Air conditioning systems of this kind are generally known. The have a refrigeration circuit, in which refrigerant compressed by a compressor is cooled via a gas cooler, then is expanded to low pressure via an expansion valve, and thus cooled down considerably. This strongly cooled refrigerant is able to cool the supply air to the passenger compartment via a heat exchanger. After that, the compressor draws in the gaseous refrigerant via an accumulator capable of storing liquid refrigerant. Thus, in these air conditioning systems, a compressor powers a refrigeration circuit. In this context, it is problematic that moisture present in the supply air to the passenger compartment condenses when cooled, and that when this heat exchanger is used for heating, the moisture evaporates and can fog the windows.

In this field, air conditioning systems have been known which either only heat, or only cool.

Also known are cooling air conditioning systems with electrical after-heating, or after-heating by engine cooling water. The latter air conditioning systems have massive problems with fogged windows when changing from cooling to heating, and when a vehicle is started with the engine cold. The air conditioning systems with electrical after-heating require a very large amount of electrical energy compared to the design approaches proposed according to the present invention.

It is, therefore, the object of the present invention to provide an air conditioning system which will not have these disadvantages.

This objective is achieved by an air conditioning system, in particular for motor vehicles, for heating and/or cooling a passenger compartment, featuring a compressor that is capable of powering at least two air conditioning circuits at the same time; i.e., in parallel. Preferred is an air conditioning system, in which a first circuit can be used for cooling and, at the same time, a second circuit can be used for heating the supply air of a passenger compartment. An air conditioning system according to the present invention features a branch point which is located downstream of the compressor on the high-pressure side and which can split the high-pressure refrigerant flow into two streams.

Preferably, an expansion valve is located downstream of the branch point in the second circuit. Moreover, a check valve can be located downstream of the branch point in the first circuit.

Particular preference is also given to an air conditioning system, in which a valve device capable of splitting the high-pressure refrigerant flow into two streams is located in the circuit downstream of the compressor on the high-pressure side.

An air conditioning system according to the present invention has the feature that a first refrigerant flow can be used for cooling and, at the same time, a second refrigerant flow can be used for heating the supply air of a passenger compartment. This has the advantage that initially the moisture is removed from the cooled supply air by a water separator, and then this supply air is heated by the second circuit, which advantageously prevents the windows from fogging.

Also preferred is an air conditioning system, in which, on the high-pressure side, the second refrigerant flow circuit branched off for heating uses the high refrigerant temperature resulting from compression to heat the supply air of the passenger compartment, while the first refrigerant flow is available to the refrigeration circuit.

In the air conditioning system according to the present invention, the high temperature of the high-pressure gas is used for heating a cooling water circuit via a heat exchanger. Moreover, an air conditioning system is preferred, in which a cooling water circuit heats the supply air of the passenger compartment via a heat exchanger. Also preferred is an air conditioning system, in which a throttling device or an expansion valve is located downstream of the heat exchanger. Moreover, an air conditioning system is preferred, in which a check valve is located downstream of the throttling device after the expansion valve; the check valve preventing refrigerant from flowing from the refrigeration circuit into the heating circuit.

It is a feature of an air conditioning system according to the present invention that, downstream of the check valve, the heating circuit joins the refrigeration circuit on the low-pressure side, i.e., on the suction side of the compressor.

Moreover, an air conditioning system is preferred, in which the high temperature of the high-pressure gas is used for heating the supply air of the passenger compartment via a heat exchanger.

Also preferred is an air conditioning system, in which a throttling device or an expansion valve is located downstream of the heat exchanger. Moreover, an air conditioning system is preferred, in which a heat exchanger that reheats the refrigerant with cooling water is located downstream of the throttling device or the expansion valve. It is a feature of an air conditioning system according to the present invention that a check valve that prevents refrigerant from flowing from the refrigeration circuit into the heating circuit is located downstream of the heat exchanger. Also preferred is an air conditioning system, in which downstream of the check valve, the heating circuit joins the refrigeration circuit on the low-pressure side, i.e., on the suction side of the compressor.

An air conditioning system according to the present invention has the feature that the additional heating circuit prevents window fogging.

Moreover, an air conditioning system is preferred, in which the cooling water circuit is constituted by a small bypass added in the water circuit of the actual cooling water circuit of the internal combustion engine; the bypass being able to be opened and closed. Also preferred is an air conditioning system, in which the heat exchanger can use heat from the ambient air, or heat from engine parts or engine block parts, or heat from the exhaust tract in place of heat from the cooling water. A further air conditioning system according to the present invention has the feature that the volume flow of engine cooling water is controllable by a thermostatic control valve in order to control the heat flow.

Moreover, an air conditioning system is preferred, in which, when turning on the air conditioning system, the supply to the compression chamber in a variable-stroke compressor is essentially shut off in order to remove liquid refrigerant from the compressor as quickly as possible. Also preferred is an air conditioning system, in which, when turning on the cold air conditioning system, the small cooling water circuit is decoupled from the colder engine cooling water circuit at least until hardly any liquid refrigerant occurs on the high-pressure side of the compressor.

It is a feature of an air conditioning system according to the present invention that the small cooling water circuit is open to the engine cooling water circuit if, after the heat is transferred to the supply air of the passenger compartment, the temperature of the small cooling water circuit is lower than the temperature of the engine cooling water. Also preferred is an air conditioning system, in which, when less heat is needed to heat the passenger compartment, the high-pressure gas flow branched off for heating is correspondingly reduced. This results in beneficial savings in fuel consumption. Moreover, an air conditioning system is preferred, in which, when the engine cooling water is warm and the intention for the passenger compartment is to be cooled more, the circulation of the small circuit is shut off so that no additional heat is input into the system. This measure also results in fuel savings.

It is a feature of an air conditioning system according to the present invention that, when turning on the air conditioning system, the supply to the compression chamber in a variable-stroke compressor is essentially shut off in order to remove liquid refrigerant from the compressor as quickly as possible, and that, at the same time, when the engine is started cold and the intention is to heat the engine cooling water while refraining from heating the passenger compartment in the quickest possible manner, the small cooling water circuit is opened to the engine cooling water circuit.

Also preferred is an air conditioning system, in which the heat input after the throttling in the heating branch is reduced as far as possible if the passenger compartment is to be cooled when the engine cooling water is warm. This measure also helps save fuel. Moreover, an air conditioning system is preferred, in which the waste heat of the heating gas is used for heating. Also preferred is an air conditioning system, in which the gases used as the refrigerant are gases which reach high temperatures, in particular 120° C, on the high-pressure side when circulated during operation. Particular preference is given to an air conditioning system which uses CO2 as a refrigerant.

The use of a heat pump makes it possible to save fuel during heating as compared to the prior art, and to transfer heat to the supply air of the passenger compartment significantly more quickly, even when the engine is cold. The object of the present invention is achieved by both the design of the system and by the situation-specific control strategies. The advantages provided by the present invention include the avoidance of fogged windows, energy savings, and synergetic effects by using other system components.

In the following, the present invention will be described with reference to the figures.

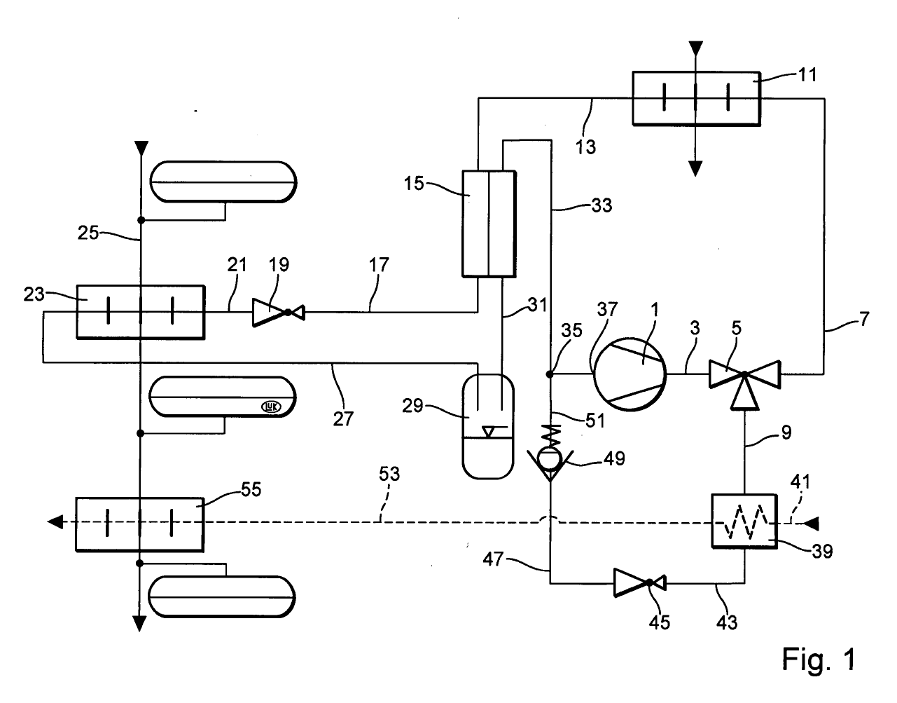

FIG. 1 shows an air conditioning circuit including an additional circuit, using a triangular process.

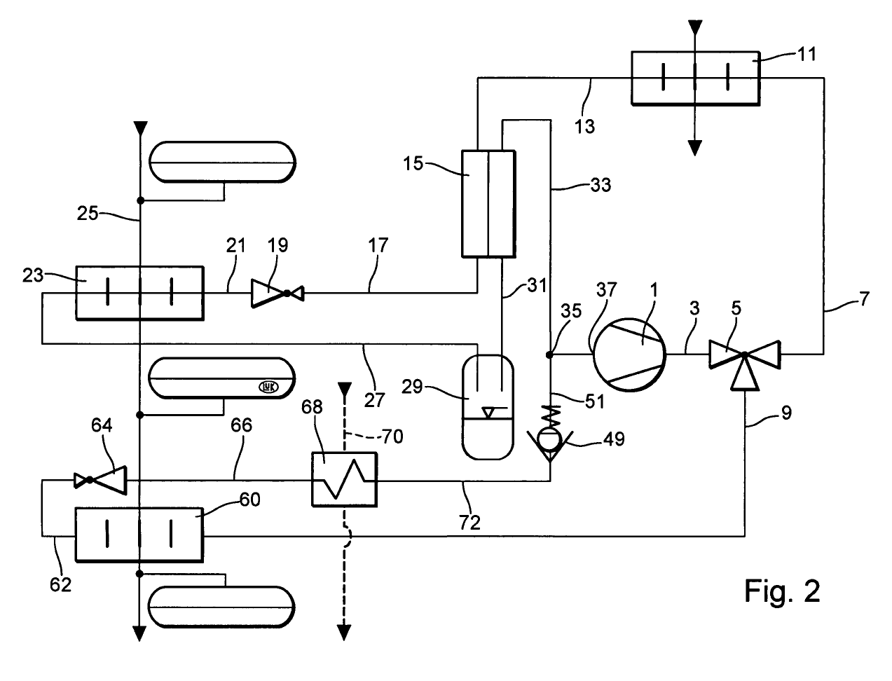

FIG. 2 shows an air conditioning circuit including an additional circuit, using a heat pump process.

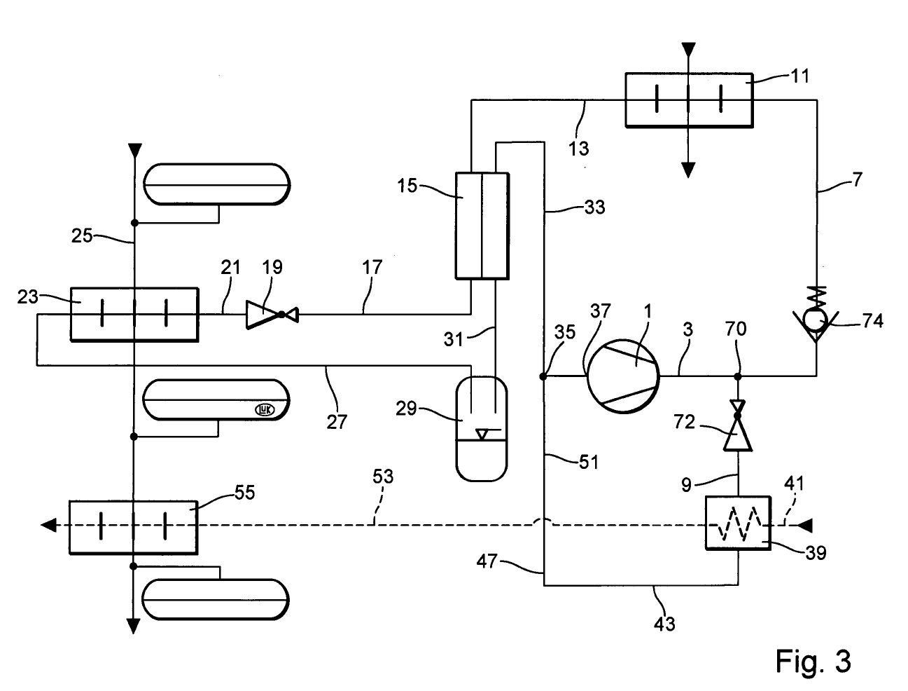

FIG. 3 shows a variant of the air conditioning circuit of FIG. 1.

A compressor 1 is connected to a valve 5 on its high-pressure side 3; i.e., on the side on which the refrigerant has become very hot because of the compression. Valve 5 is capable of splitting the high-pressure refrigerant flow exiting compressor 1 into two flow paths, a flow path 7 for the refrigeration circuit and a flow path 9 for the heating circuit. Flow path 7 continues, in a known manner, to a gas cooler 11, in which the heated high-pressure gas is cooled down.

Via a connecting line 13, the refrigeration circuit leads to an internal heat exchanger 15, and from there, the circuit continues via a connecting line 17 to an expansion valve 19, in which the refrigerant is expanded, and thus cooled to a low temperature. Via a connecting line 21, the cold refrigerant is then conveyed into an evaporator 23, which is traversed by the supply air stream in line 25 for the passenger compartment. In the process, the supply air stream is correspondingly cooled, while the refrigerant absorbs heat here. Via a connecting line 27, the refrigerant is conveyed from evaporator 23 to an accumulator 29, in which liquid and gaseous fractions of the refrigerant are separated from each other. Via a connecting line 31, the refrigerant is passed through internal heat exchanger 15 once more, and is then conveyed via connecting line 33 to a junction point 35, and from there to low-pressure side 37 of compressor 1.

The additional parallel heating circuit branching off via connecting line 9 initially runs via a heat exchanger 39, which is connected to a cooling water circuit 41 so that the cooling water can absorb the heat of the high-pressure gas. The heating circuit continues via a connecting line 43 to an expansion valve 45, which is used to expand the refrigerant to the low suction pressure of the compressor. A connecting line 47 leads on to a check valve 49, from where the heating circuit leads via a connecting line 51 to junction point 35, and thus, to low-pressure suction side 37 of the compressor. Check valve 49 ensures that only refrigerant from the heating circuit can get into the suction area 37 of the compressor, but that, on the other hand, no refrigerant can flow backwards from the low-pressure area of the refrigeration circuit into the heating circuit. Cooling water circuit 41 leads via heat exchanger 39, and continues via a connecting line 53 to a heat exchanger 55, which is also traversed by the supply air stream for the passenger compartment; the supply air stream absorbing heat from cooling water circuit 41 via heat exchanger 55. The purpose of the two air conditioning circuits is that the supply air is initially cooled in evaporator 23, and that any existing condensed water is thereby separated out of the supply air and precipitated. After that, the supply air is slightly heated in heat exchanger 55, and subsequently conveyed into the passenger compartment to prevent the windows from fogging, as is otherwise often the case, in particular when, as is often proposed, the system is operated in reverse, namely as a heater and the damp evaporator is used for heating so that water present on it evaporates abruptly.

This air conditioning system will now be explained again in terms of its pattern of operation. To prevent the windows from fogging inside the passenger compartment, the air needs to be slightly dried. This is accomplished by the following three steps:
cooling the supply air of the passenger compartment
removing any condensed water
heating the supply air by at least a small amount if warm air is requested by the driver or needed to dry the windows.

The cooling of the supply air is accomplished by a refrigeration circuit powered by compressor 1. If water is condensed in the process, the condensed water is removed from the air stream as soon as possible. The heating of the air is accomplished by a downstream heat exchanger 55, which receives its heat mainly from the hot gas (high-pressure side) of the same compressor 1, at least when the engine is cold. Thus, the same compressor 1 can be used to simultaneously power a refrigeration circuit and a heating circuit; the cooling and heating being adjustable by different actuators in the cooling system (valves, adjustable throttles, etc.), thus making it possible to set a temperature and air humidity desired in the passenger compartment. In particular, a valve 5 that distributes the refrigerant flow among the refrigeration circuit and the heating circuit is required on the high-pressure side of the compressor.

The system approach in FIG. 1 represents a so-called “triangular process”: Heating a small cooling water circuit 41 using part of the high-pressure gas, and transferring the heat of the small cooling circuit to the supply air of the passenger compartment. If the cooling water temperature of the driving engine is sufficiently high, or the engine cooling water requires additional heating, the small cooling water circuit can be opened and supplied with the cooling water of the engine. The high-pressure gas used for heating the small cooling water circuit is subsequently throttled and returned to the system on the suction side of the compressor.

FIG. 2 shows an air conditioning system according to the present invention, in which the heating circuit represents a complete heat pump. The refrigeration circuit remains as depicted in FIG. 1, and is therefore provided with the same reference numerals, and will not be described again here. The differences lie in the heating circuit, which starts with line 9 at stream-splitting valve 5. Line 9, into which part of the hot high-pressure gas flows, is run to a heat exchanger 60, which heats the supply air to the passenger compartment using the hot high-pressure gas. The high-pressure gas, which has now cooled down correspondingly, flows via a connecting line 62 to an expansion valve 64, where it is expanded to the lower pressure prevailing also on suction side 37 of compressor 1. The refrigerant of this heating circuit is conveyed via a connecting line 66 to a heat exchanger 68, in which heat from the engine cooling water is delivered to the refrigerant via a line 70.

Via a further connecting line 72, the circuit is then routed via check valve 49 and connecting line 51 to the junction point 35 with the refrigeration circuit.

Thus, FIG. 2 represents the cycle of a complete heat pump. Part of the high-pressure gas of the compressor heats the supply air of the passenger compartment. After that, the high-pressure gas is throttled, and subsequently supplied with heat before it is returned to the system on the suction side of the compressor. The heat supplied after the throttling preferably comes from the engine cooling water, from the ambient air, or from hot parts of the engine or engine block, or from the exhaust tract. In this connection, it is preferred to control the heat flow, for example, by controlling the volume flow of the engine cooling water, in particular using a thermostatic control valve.

FIG. 3 shows a variant of the air conditioning circuit of FIG. 1. Identical system components are provided with the same reference numerals, and are sufficiently explained by the description in FIG. 1. The fundamental difference from FIG. 1 is that in place of valve 5 of FIG. 1, only a branch point 70, at which the heating circuit and the refrigerant circuit separate, is shown at this point of the circuit. Located in the heating circuit downstream of branch point 70 is an expansion valve 72, downstream of which the heating circuit leads via connecting line 9 to heat exchanger 39. In the continuation of the refrigeration circuit downstream of branch point 70, a check valve 74 is located which prevents refrigerant from flowing back from the refrigeration circuit in reverse direction. Expansion valve 45 of FIG. 1 and check valve 49 of FIG. 1 are omitted. The main advantage of this circuit design is that no switchover valve 5 is needed. The heating circuit is controlled by opening and closing expansion valve 72, and the refrigeration circuit is controlled by opening and closing expansion valve 19. This eliminates the need for valve 5 which, for example, must handle large flow areas in the circuit, and which can therefore be correspondingly expensive and prone to failure because of large control magnets. The flow area to be controlled in an expansion valve is distinctly smaller, and can therefore be opened, closed and controlled with considerably less effort. When the refrigeration circuit is closed by closing expansion valve 19, then the back pressure building up in this section of the circuit will cause check valve 74 to close and to thereby prevent refrigerant from continuing to flow into and condense in gas cooler 11, which would result in a constantly increasing amount of refrigerant condensate at this point in the circuit. Via the heating operation occurring in this case in the heating circuit, expansion valve 72 is opened for this purpose, and the desired heating effect is achieved with the still relatively hot compressor gas via heat exchanger 39. The refrigerant of the heating circuit that has been expanded to the compressor suction pressure is then returned to the compressor via junction point 35.

In the cooling water-to-CO2 heat exchanger, such a large amount of heat can be injected after the heating phase that extremely high suction pressures near the design pressure can occur. To counteract this, it is advantageous to control this heat exchanger thermostatically. A thermostatic control valve senses the cooling water temperature in this heat exchanger, and independently reduces the cooling water flow in such a manner that the temperature in this heat exchanger does not exceed a preset maximum value. In this manner, the suction pressure is limited.

For system control and to prevent limit states, the following strategies are preferred for the heating of the supply air of the passenger compartment:
1. Triangular process:
   a) When turning on the cold system, the supply to the compression chamber in a variable-stroke compressor is essentially shut off in order to remove liquid refrigerant from the compressor as quickly as possible.
   b) When turning on the cold system, the small cooling water circuit is decoupled from the colder engine cooling water circuit at least until hardly any liquid refrigerant occurs on the high-pressure side of the compressor.
   c) If, after the heat is transferred to the supply air of the passenger compartment, the temperature of the small cooling water circuit is lower than the temperature of the engine cooling water, then the small cooling water circuit is opened to the engine circuit.
   d) When less heat is needed to heat the passenger compartment, then the high-pressure gas flow branched off for heating is correspondingly reduced to save fuel.
   e) When the engine cooling water is warm and the intention for the passenger compartment is rather to be cooled, then the circulation of the small cooling water circuit is shut off. In this manner, no additional heat is input into the system, thus saving fuel.
   f) If, when an engine is started cold, the intention is to heat the engine cooling water while refraining from heating the passenger compartment in the quickest possible manner, the small cooling water circuit is opened to the engine cooling water circuit, taking into account a).
2. Heat pump:
   a) When turning on the cold system, the supply to the compression chamber in a variable-stroke compressor is essentially shut off in order to remove liquid refrigerant from the compressor as quickly as possible.
   b) If, when the engine cooling water is warm, the intention for the passenger compartment is rather to be cooled, then the heat input after the throttling in the heating branch is reduced as far as possible.

The claims filed with the application are proposed formulations and do not prejudice the attainment of further patent protection. The applicant reserves the right to claim still other combinations of features that, so far, have only been disclosed in the specification and/or the drawings.

The antecedents used in the dependent claims refer, by the features of the respective dependent claim, to a further embodiment of the subject matter of the main claim; they are not to be understood as renouncing attainment of an independent protection of subject matter for the combinations of features of the dependent claims having the main claim as antecedent reference.

Since, in view of the related art on the priority date, the subject matters of the dependent claims may constitute separate and independent inventions, the applicant reserves the right to make them the subject matter of independent claims or of divisional applications. In addition, they may also include independent inventions, whose creation is independent of the subject matters of the preceding dependent claims.

The exemplary embodiments are not to be understood as limiting the scope of the invention. Rather, within the framework of the present disclosure, numerous revisions and modifications are possible, in particular such variants, elements and combinations and/or materials, which, for example, by combining or altering individual features or elements or method steps described in connection with the general description and specific embodiments, as well as the claims, and contained in the drawings, may be inferred by one skilled in the art with regard to achieving the objective, and lead, through combinable features, to a new subject matter or to new method steps or sequences of method steps, also to the extent that they relate to manufacturing, testing, and operating methods.

1-34. (canceled)

35. An air conditioning system for heating and/or cooling a passenger compartment of a motor vehicle, comprising a compressor, the compressor powering at least two air conditioning circuits at the same time.

36. The air conditioning system of claim 35, wherein the at least two air conditioning circuits include a first circuit for cooling supply air for the passenger compartment and a second circuit for heating supply air for the passenger compartment

37. The air conditioning system of claim 36, wherein the first circuit can be used for cooling at the same time the second circuit is used for heating.

38. The air conditioning system of claim 35, wherein the compressor includes a high-pressure side and a low pressure side, the at least two air conditioning circuits located downstream of the high pressure side, and wherein a branch point is provided between the high pressure side and the at least two air conditioning circuits.

39. The air conditioning system of claim 36, wherein the compressor includes a high-pressure side and a low pressure side, the first and second circuits located downstream of the high pressure side, and wherein a branch point is provided between the high pressure side and the first and second circuits, and wherein an expansion valve is located downstream of the branch point in the second circuit.

40. The air conditioning system, of claim 39, wherein a check valve is located downstream of the branch point in the first circuit.

41. The air conditioning system of claim 36, wherein the compressor includes a high-pressure side and a low pressure side, the at least two air conditioning circuits located downstream of the high pressure side, and wherein a branch point is provided between the high pressure side and the first and second circuits, wherein a check valve is located downstream of the branch point in the first circuit.

42. An air conditioning system for heating and/or cooling a passenger compartment of a motor vehicle comprising a compressor, the compressor having a low pressure side and a high pressure side, a valve device located downstream of the compressor on the high-pressure side, the valve device splitting a high-pressure refrigerant flow from the compressor into two streams.

43. The air conditioning system of claim 42, wherein the two streams comprise a first refrigerant flow and a second refrigerant flow, and wherein the first refrigerant flow is used for cooling supply air for the passenger compartment and, at the same time, the second refrigerant flow is used for heating supply air for the passenger compartment.

44. The air conditioning system of claim 43, wherein the first refrigerant flow is coupled to a refrigeration circuit and the second refrigerant flow is coupled to a heating circuit, and wherein, on the high-pressure side, the second refrigerant flow uses the high refrigerant temperature resulting from compression in the compressor to heat the supply air of the passenger compartment.

45. The air conditioning system of claim 44, wherein the high temperature of the second refrigerent flow is used to heat a cooling water circuit via a heat exchanger.

46. The air conditioning system of claim 45, wherein the cooling water circuit heats the supply air of the passenger compartment via another heat exchanger.

47. The air conditioning system of claim 45, wherein a throttling device or an expansion valve is located downstream of the heat exchanger.

48. The air conditioning system of claim 47, wherein a check valve is located downstream of the throttling device or the expansion valve; the check valve preventing refrigerant from flowing from the refrigeration circuit into the heating circuit.

49. The air conditioning system of claim 48, wherein downstream of the check valve, the heating circuit and the refrigeration circuit are coupled to the low pressure side of the compressor.

50. The air conditioning system of claim 44, wherein the high temperature of the second refrigerent flow is used for heating the supply air of the passenger compartment via a heat exchanger.

51. The air conditioning system of claim 50, wherein a throttling device or an expansion valve is located downstream of the heat exchanger.

52. The air conditioning system of claim 51, wherein another heat exchanger that reheats the refrigerant with cooling water is located downstream of the throttling device or the expansion valve.

53. The air conditioning system of claim 52, wherein a check valve is located downstream of the another heat exchanger; the check valve preventing refrigerant from flowing from the refrigeration circuit into the heating circuit.

54. The air conditioning system of claim 53, wherein downstream of the check valve, the heating circuit and the refrigeration circuit are coupled to the low pressure side of the compressor.

55. The air conditioning system of claim 44, wherein the heating circuit prevents window fogging.

56. The air conditioning system of claim 45 wherein the cooling water circuit comprises a bypass added in a water circuit of a cooling water circuit of an internal combustion engine, the bypass being able to be opened and closed.

57. The air conditioning system of claim 51, wherein the another heat exchanger reheats the refrigerant with heat from ambient air, or heat from engine parts or engine block parts, or heat from the exhaust tract.

58. The air conditioning system of claim 52, wherein a volume flow of the cooling water is controllable by a thermostatic control valve in order to control the heat flow.

59. The air conditioning system of claim 49, wherein the compressor is a variable-stroke compressor including a compression chamber, and, upon turning on the air conditioning system, the supply to the compression chamber in the variable-stroke compressor is essentially shut off in order to remove liquid refrigerant from the compressor.

60. The air conditioning system of claim 49, wherein when turning on the air conditioning system to cool the passenger compartment, the cooling water circuit is decoupled from a colder, engine cooling water circuit, at least until substantially no liquid refrigerant occurs on the high-pressure side of the compressor.

61. The air conditioning system of claim 60, wherein the cooling water circuit is opened to the engine cooling water circuit if, after the heat is transferred to the supply air of the passenger compartment, the temperature of the cooling water circuit is lower than the temperature of the engine cooling water circuit.

62. The air conditioning system of claim 49, wherein when less heat is needed to heat the passenger compartment, the second refrigerent flow is correspondingly reduced.

63. The air conditioning system of claim 49, wherein when engine cooling water in an engine cooling water circuit is warm and the passenger compartment is to be further cooled, the circulation of the cooling water circuit is shut off so that no additional heat is input into the system.

64. The air conditioning system of claim 59, wherein when the engine is started cold and the engine cooling water is to be heated while refraining from heating the passenger compartment, the cooling water circuit is opened to the engine cooling water circuit.

65. The air conditioning system of claim 54, wherein when turning on the air conditioning system to cool the passenger compartment, the supply to the compression chamber in a variable-stroke compressor is essentially shut off in order to remove liquid refrigerant from the compressor.

66. The air conditioning system of claim 54, wherein heat input after throttling in the heating circuit is reduced if the passenger compartment is to be cooled when the engine cooling water is warm.

67. The air conditioning system of claim 36, wherein waste heat of hot gas is used for heating.

68. The air conditioning system of claim 42, wherein gases on the high pressure side reach 120 C during operation of the compressor.

69. The air conditioning system of claim 42, wherein the refrigerant is CO2.
